(19) United States
(12) Patent Application Publication
(10) Pub. No.: US 2018/0104885 A1
(43) Pub. Date: Apr. 19, 2018

(54) UNIT FOR MOULDING CONTAINERS PROVIDED WITH AN OFFSET RADIATOR AND AN INTEGRATED TEMPERATURE PROBE

(71) Applicant: SIDEL PARTICIPATIONS, Octeville-sur-Mer (FR)

(72) Inventors: Olivier ALIX, Octeville-sur-Mer (FR); Nicolas CHOMEL, Octeville-sur-Mer (FR); Gilles LEROUX, Octeville-sur-Mer (FR); Eric VIGNET, Octeville-sur-Mer (FR); Matthieu BREARD, Octeville-sur-Mer (FR)

(21) Appl. No.: 15/566,671

(22) PCT Filed: Apr. 1, 2016
(86) PCT No.: PCT/FR2016/050748

§ 371 Date: Oct. 13, 2017

(30) Foreign Application Priority Data
Apr. 15, 2015 (FR) 1553350

(51) Int. Cl. B29C 49/48; B29C 49/78; B29C 49/06; B29C 33/02

(52) U.S. Cl. CPC B29C 49/4823; B29C 49/786; B29C 2035/0211; B29C 33/02; B29C 49/063

(57) ABSTRACT

A molding unit for producing a container, that includes: —a mold having the footprint of the container, including a pair of shells each having an inner wall; —a pair of shell holders onto each of which a shell is removably attached; —a device for controlling the temperature of the mold, that includes: ◯at least one radiator integrated into a shell holder, ◯at least one temperature probe integrated into a shell, for measuring the temperature in the vicinity of the inner wall, ◯a variator connected to the temperature probe and to the radiator, the variator being arranged to modulate the temperature of the radiator depending on the temperature measured by the probe.

The invention relates to the production of containers, by blow molding or stretch blow molding, from blanks of plastic material such as PET (polyethylene terephthalate).

The technique of blow molding a container comprises, in the first place, an operation for heating a blank (whether it is a preform or an intermediate container having undergone a first blow-molding operation from a preform) at a predetermined temperature that is higher than the glass transition temperature of the material that makes up the blank.

In the second place, the blank thus heated is introduced into a mold having a wall with the impression of a body of the container to be formed, and a fluid (generally air) under pressure (ordinarily between 20 and 40 bars) is injected into the blank to flatten it against the wall and thus to impart to it the shape of the body of the container.

A stretching operation can be provided, consisting, during the blow molding, in stretching the blank by means of a sliding rod that ensures the holding of the container in the axis of the mold.

It is customary to thermally regulate the molds to keep them either at a temperature in the vicinity of the ambient temperature (on the order of 20° C.), or, in contrast, at a relatively high temperature (on the order of—or higher than—about 100° C.).

In the first case, it is a matter of cooling the material when it comes into contact with the wall of the mold, so as to rapidly solidify it and thus maintain the taking of an impression. This technique is currently used in the production of containers designed to receive ordinary liquids such as plain water.

In the second case, it is a matter rather of heating the material from the moment that it comes into contact with the wall of the mold, so as to increase its crystallinity (and therefore its mechanical strength) thermally. This technique is currently used in the production of containers designed to receive liquids that are filled hot, i.e., at a temperature greater than or equal to about 90° C. (particularly tea, or else juices—or fruity drinks—just pasteurized).

It is known to ensure the heat regulation of a mold by means of a heat-transfer fluid (such as water or oil) circulating in channels made in the thickness of the mold. This technique, however, poses problems of fluid-tightness and requires a significant flow and reserve of fluid. Also, the drilling of the channels in the mold assumes that it is thick (and therefore heavy).

It is also known to ensure the heat regulation of a mold by means of electrical resistors housed in bores made in the mold, as illustrated in the European patent application EP 2 794 234 (Sidel Participations) or its U.S. equivalent US 2014/0377394. This technique solves the problems of fluid-tightness and of fluid reserve mentioned above, but not that of the thickness (and therefore of the weight) of the mold.

The technique described in the European patent EP 1 753 597, which consists in mounting a serpentine resistor between the mold and its support, causes significant heat losses by heat dissipation. To compress the coil to increase the heat contact with the mold is not a solution, because that would lead to its damage and therefore to its malfunction.

A first objective is to propose a molding unit equipped with a device for regulating the heat of the mold whose structure makes it possible to reduce its weight.

A second objective is to propose a molding unit that makes it possible to ensure a proper effectiveness of the heat regulation.

For this purpose, a molding unit is proposed for the production of a container from a blank of plastic material, this molding unit comprising:
a mold having the impression of the container, this mold including a pair of shells, each having an inner wall defining a portion of the impression of a body of the container to be formed, these shells being mounted mobile in relation to one another between an open position in which the shells are separated from one another and a closed position where the shells are applied against one another to form mutually the impression of the body of the container;
a pair of shell-carriers, on each of which a shell is attached in a removable manner;
a device for heat regulation of the mold that comprises:
   at least one radiator able to exchange heat with it, the or each radiator being integrated with a shell-carrier,
   at least one temperature probe integrated with a shell to measure the temperature near the inner wall,
   a variator connected, on the one hand, to the temperature probe and, on the other hand, to the radiator, this variator being arranged to modulate the temperature of the radiator as a function of the temperature measured by the probe.

The offset of the radiators toward the shell-carrier makes it possible to reduce the thickness of the shell, which makes it possible to reduce the weight and thus to save on material while reducing the inertia of the molding unit, benefitting overall productivity.

Various additional characteristics can be provided, alone or in combination:
the heat regulation device comprises a radiator integrated with each shell-carrier;
the heat regulation device comprises:
   a primary connector connected to the probe and mounted in the shell carrying the probe, and
   a secondary connector connected to the variator and mounted in the shell-carrier to which the shell carrying the probe is attached, this secondary connector being complementary to the primary connector so as to work with it when the shell is attached on its shell-carrier;
the radiator comprises at least one electrical resistor housed in a supplementary hole made in the shell-carrier;
the radiator comprises a series of electrical resistors housed in a series of supplementary holes made in the shell-carrier;
the probe is mounted in a blind hole made in the shell, the probe extending to an internal end of the hole located near the inner wall of the shell;
the mold includes a mold bottom having an upper surface having the impression of the bottom of the container to be formed.

Other objects and advantages of the invention will be brought out in the description of an embodiment, made below with reference to the accompanying drawings in which:

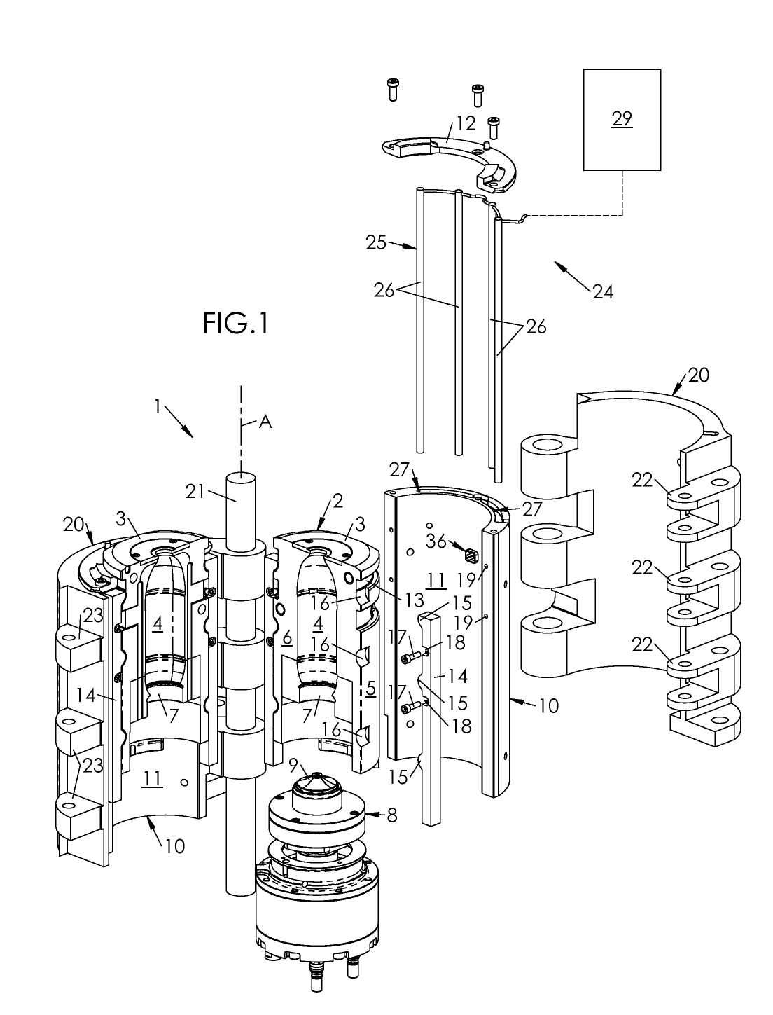

FIG. 1 is a view in perspective, partially exploded, showing a molding unit;

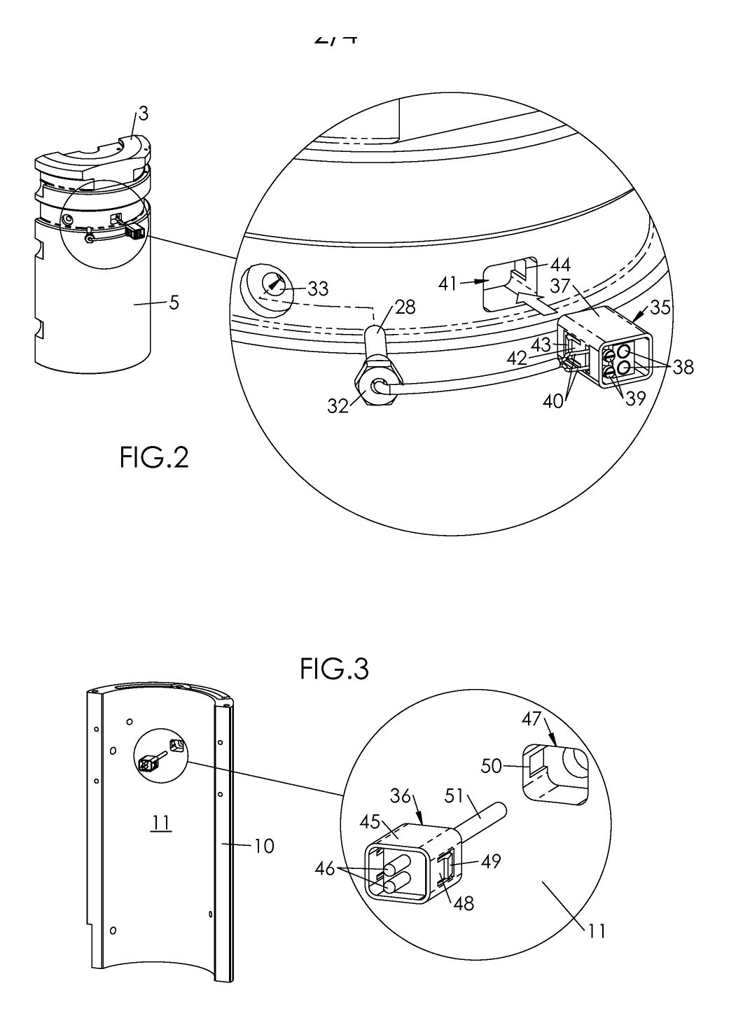

FIG. 2 is an exploded view in perspective showing a shell of the molding unit of FIG. 1, with—in an inset—a detail on a larger scale;

FIG. 3 is an exploded view in perspective showing a shell-carrier of the molding unit of FIG. 1 on which the shell of FIG. 2 is intended to be fastened, with—in an inset—a detail on a larger scale;

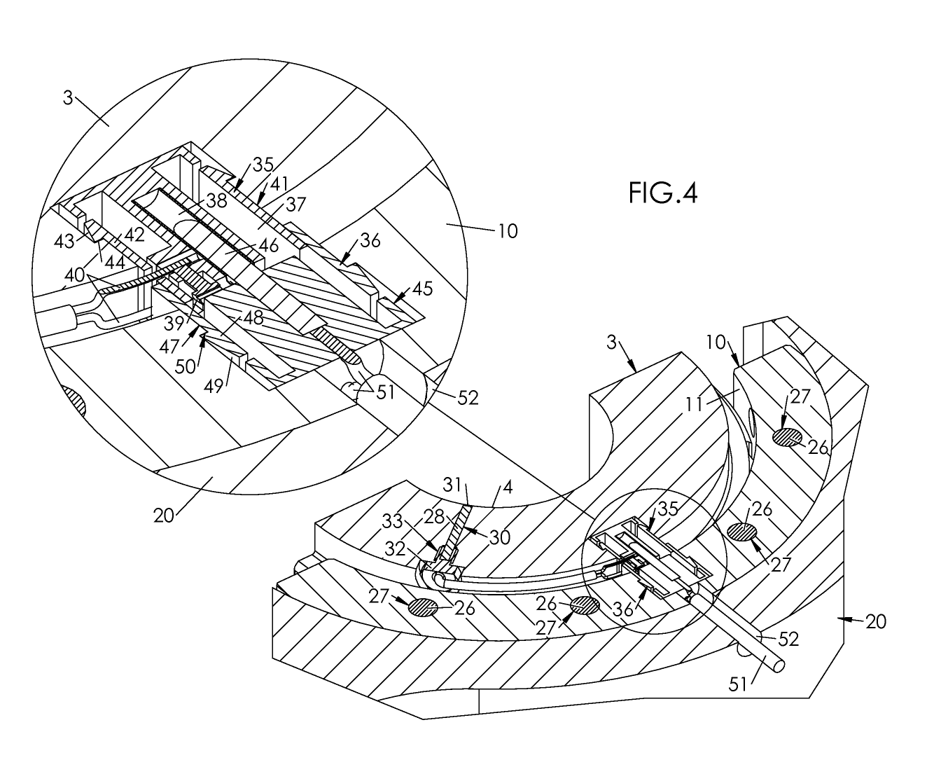

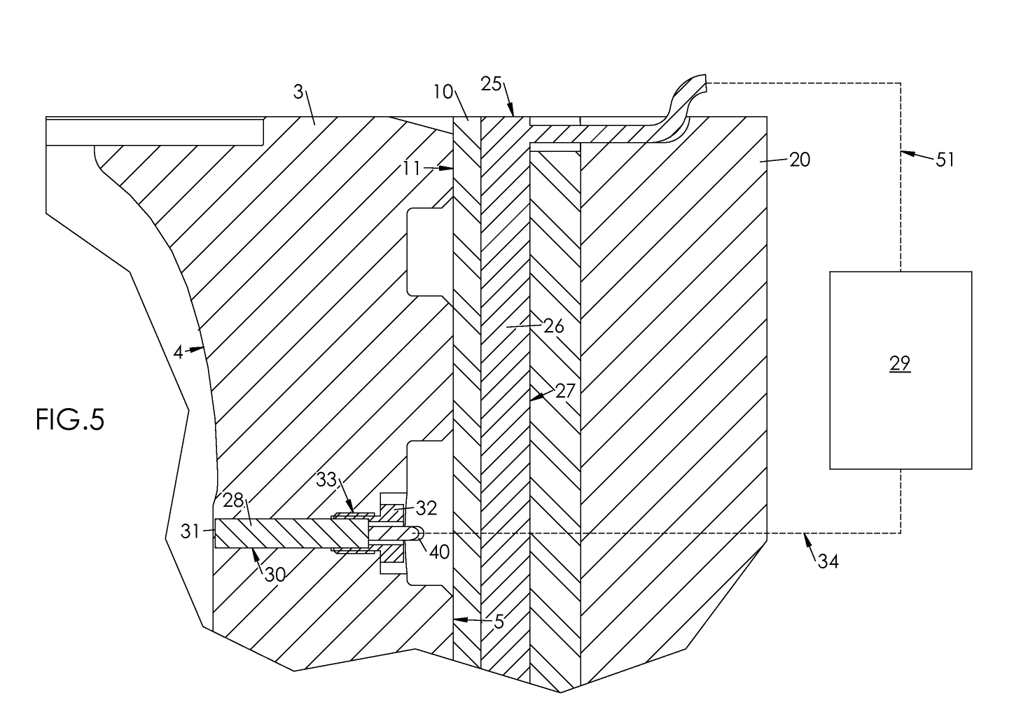

FIG. 4 is a view in perspective and in horizontal cutaway illustrating an embodiment of electrical connection wiring of the probe to the variator, with—in an inset—a detail on a larger scale;

FIG. 5 is a partial view in vertical cutaway illustrating the mounting of the probe in the shell.

Shown in FIG. 1 is a molding unit 1 for producing a container—such as a bottle—from a blank made of plastic material, typically made of PET. The blank can be a raw injection preform, or a container blank having, from a preform, undergone one or more previous preforming operations.

The container comprises, in a standard manner, an approximately cylindrical body, a bottom that closes the body at a lower end of it, and a neck formed at an upper end of the body and through which the container can be filled.

This molding unit 1 can be part of a series of similar units mounted on a common rotating carousel that equips a production line machine and a machine for mass production of containers that are all identical, at high speed (on the order of several tens of thousands per hour).

The molding unit 1 comprises, in the first place, a mold 2 having the impression of the container to be formed. This mold 2 includes a pair of half-molds 3, also called half-shells (or more simply shells), each having an inner wall 4 that defines a portion of the impression of the body of the container to be formed. In the example illustrated, the shells 3 are symmetrical, and their inner walls 4 each define a half-impression of the body of the container. Each shell 3 has an approximately cylindrical outer surface 5 and a flat inner surface 6 from which the half-impression is hollowed out.

The shells 3 are preferably made from a metal material (for example made from aluminum or from an alloy of aluminum, or else from steel, preferably stainless) and are mounted mobile in relation to one another between an open position in which the shells 3 are separated from one another (FIG. 1) and a closed position in which the shells 3 are applied against one another mutually to form the impression of the body of the container, their inner surfaces 6 lining up to form together a junction plane.

According to an embodiment illustrated in FIG. 1, the shells 3 are hinged in rotation in relation to one another around a common axis A. As a variant, the shells 3 could be mounted in translation in relation to one another, perpendicular to their inner surfaces 6.

The shells 3 mutually define, in closed position, a lower opening 7, and the mold 2 includes a mold bottom 8 that has an upper surface 9 having the impression of the bottom of the container to be formed, this mold bottom 8 being received (optionally in a sliding manner) in the lower opening 7.

As is seen in FIG. 1, the molding unit 1 further comprises a pair of shell-carriers 10, on each of which a shell 3 is attached in a removable manner.

Each shell-carrier 10 appears in the shape of a half-cylinder (which can be made from a metal material, for example from aluminum or from an alloy of aluminum) having a cylindrical inner surface 11 that is complementary to the outer surface 5 of the corresponding shell 3.

Each shell-carrier 10 is mounted on a half-ring retaining collar 12 that fits into an outer groove 13 made in the corresponding shell 3 to ensure the vertical immobilization of the shell 3.

The immobilization in rotation of the shell 3 in relation to its shell-carrier 10 is achieved by means of lateral braces 14 provided with protrusions 15 that are engaged in complementary hollow-formed recesses 16 in the shell 3 from its inner surface 6. Each lateral brace 14 is secured to the respective shell-carrier 10 by means of screws 17 that, passing through notches 18 made in the lateral brace 14, catch in threaded holes 19 made in a vertical edge of the respective shell-carrier 10.

The half-ring retaining collar 12 and the lateral braces 14 make it possible to ensure the removable attachment of the shell 3 in its shell-carrier 10. It is thus possible, without changing the shell-carrier 10, to replace the shell 3 to make possible the production of another model of container.

According to an embodiment illustrated in FIG. 1, the molding unit 1 also comprises a pair of mold-carrier brackets 20 in each of which a shell-carrier 10 is attached, for example by screwing. In the example illustrated, the mold-carrier brackets 20 are mutually hinged in rotation around the axis A, which is defined by a shaft 21.

In a variant embodiment, not shown, the shell-carriers 10 and the mold-carrier brackets 20 form a single-unit assembly. In other words, each mold-carrier bracket 20 ensures the function of shell-carrier.

The mold-carrier brackets 20 are driven in rotation around the axis A by a control mechanism (not shown), which can be of the type having a cam and link rod; the mold-carrier brackets 20 can furthermore be locked in closed position of the mold 2 by a locking system comprising devises 22 defined on one of the mold-carrier brackets 20, and complementary bolts 23 defined on the other mold-carrier bracket 20, a rod (not shown) jointly passing through the devises 22 and the bolts 23 to make them integral in a removable manner.

The molding unit 1 further comprises a device 24 for heat regulation of the mold 2, which comprises at least one radiator 25, able to exchange heat with it, this radiator 25 being integrated with a shell-carrier 10 (i.e., housed in the mass of the shell-carrier 10). The term “radiator” designates an element designed to exchange heat with its surroundings to ensure the cooling of it or, in contrast, the heating of it.

The radiator 25 could appear in the form of a channel (or several channels) through which a heat-exchanging fluid passes. However, according to an embodiment illustrated in FIG. 1, the radiator 25 is of the electric type (to perform the heating of the mold 2) and comprises at least one electrical resistor 26 housed in a complementary hole 27 made in the shell-carrier 10. In the example illustrated, each radiator 25 comprises a series of pen-shaped cylindrical resistors 26, each housed axially in a complementary cylindrical hole 27 made in the shell-carrier 10. According to an embodiment illustrated in FIG. 1, the resistors 26, numbering four, are distributed circularly in a uniform manner in the shell-carrier 10, at an approximately equal distance from one another. To ensure heat regulation of the mold 2 on its periphery, the heat-regulating device 24 advantageously comprises two radiators 25, each mounted (in a similar manner) in a respective shell-carrier 10.

The resistors 26 of each radiator 25 can be mounted in series or in parallel and connected to an electric terminal (not shown), optionally outside of the molding unit 1.

The heat-regulating device 24 further comprises at least one temperature probe 28 integrated with at least one of the shells 3 to measure its temperature there near the inner wall 4, as well as a variator 29 connected, on the one hand, to the temperature probe 28 and, on the other hand, to the radiator 25, this variator 29 being arranged to modulate the temperature of the radiator 25 as a function of the temperature measured by the temperature probe 28. A single temperature probe 28 can be provided, but it is also possible to provide several temperature probes 28, mounted in the same shell 3 at several locations (for example, at different heights), or else in both shells 3 to measure the temperature near each wall 4.

The variator 29 ensures the adjustment and regulation of the power dissipated by the radiator 25 as a function of the temperature measured by the temperature probe 28.

The temperature probe 28 is, for example, a thermocouple. According to an embodiment illustrated in the figures, the temperature probe 28 is mounted in a blind hole 30 made in the shell 3 and extends to an inner end 31 of the blind hole 30, located near the inner wall 4 of the shell 3.

To ensure the removable attachment of the temperature probe 28 on the shell 3, the temperature probe 28 can be mounted on a threaded base 32 that is screwed into a threaded hole 33 made in a manner that is coaxial with the blind hole 30.

The temperature probe 28 is connected to the variator 29 by means of a physical (i.e., electrical) or electromagnetic (wireless) connection 34 by which the temperature probe 28 transmits its temperature measurement to it.

In the example illustrated, the connection of the temperature probe 28 is physical, the connection 34 appearing in the form of an electric cable. The connection 34 of the temperature probe 28 to the variator 29 can go through the shell-carrier 10 (and optionally the mold-carrier bracket 20), and it is in this case advantageous to make the connection of the temperature probe 28 to the variator 29 using a quick connector.

More specifically, according to an embodiment illustrated in the figures, and more particularly in FIGS. 2, 3 and 4, the heat-regulating device 24 comprises a primary connector 35 connected to the temperature probe 28 and mounted in the shell 3 that carries it, and a secondary connector 36 connected to the variator 29 and mounted in the corresponding shell-carrier 10 (i.e., the shell-carrier 10 to which the shell 3 carrying the temperature probe 28 is attached).

The secondary connector 36 is complementary to the primary connector 35 so as to work with it when the shell 3 is attached on its shell-carrier 10.

In the example illustrated in FIGS. 2, 3 and 4, the primary connector 35 is of the female type, and the secondary connector 36 of the male type.

More specifically, the primary connector 35 comprises, for example, a case 37, advantageously made of plastic material, which carries conductive ducts 38 to which electric wires 40 for connection to the temperature probe 28 can be connected in a removable manner (for example by screws 39).

The primary connector 35 can be attached in a removable manner on the shell 3 by being, for example, housed in a complementary hollow recess 41 made in the outer surface 5 of the shell 3. The attaching of the primary connector 35 to the shell 3 can be performed by snapping-on. For this purpose, the case 37 comprises, for example, a pair of elastic tabs 42, each equipped with a clamp 43 that engages with a shoulder 44 made in a side wall of the hollow recess 41.

The mounting of the temperature probe 28 and of the primary connector 35 in the shell 3 is illustrated by the arrows in the detail inset of FIG. 2. The temperature probe 28 is introduced into the blind hole 30, the base 32 being screwed into the threaded hole 33. The primary connector 35 is fitted into the hollow recess 41, the tabs 42 of the case 37 being snapped into the shoulders 44. The electrical connection of the temperature probe 28 to the secondary connector 36 can be performed prior to their respective mounting (such as in the example illustrated in FIG. 2), or after it.

Likewise, the secondary connector 36 comprises, for example, a case 45, advantageously made of plastic, which can be fitted onto the case 37 of the primary connector 35.

In the illustrated example, the case 45 of the secondary connector 36 carries conductive pins 46 that are complementary to the ducts 38 and able to be fitted into them, producing the electrical continuity of the connection 34.

The secondary connector 36 can be attached in a removable manner on the shell-carrier 10 by being, for example, housed in a complementary hollow recess 47 made in the inner surface 11 of the shell-carrier 10.

The attachment of the secondary connector 36 to the shell-carrier 10 can be performed by snapping-on. For this purpose, the case 45 comprises, for example, a pair of elastic tabs 48, each equipped with a clamp 49 that engages with a shoulder 50 made in a side wall of the hollow recess 47.

As is seen in FIG. 4, the pins 46 are connected to the variator 29 by a conductor 51 that can go through not only the shell-carrier 10 but also the corresponding mold-carrier bracket 20, through an opening 52 made in it.

During the attaching of the shell 3 onto its shell-carrier 10, the secondary connector 36 works with the primary connector 35, the cases 37, 45 fitting together at least partially into one another and the pins 46 being introduced into the ducts 38, thus producing the electrical continuity between the probe 28 and the variator 29. Concurrently, a heat contact is made between the outer surface 5 of the shell 3 and the inner surface 11 of the shell-carrier 10, which makes possible an exchange of heat between them and thus guarantees that the calories produced by the radiator(s) 25 are routed to the shell 3 by way of the shell-carrier 10.

The molding unit 1 that has just been described has the following advantages.

First, the fact that the radiator(s) 25 is (are) offset from the shell 3 while being integrated into the shell-carrier(s) 10 makes it possible to free the corresponding shell 3, and therefore to refine it by reducing the amount of material needed to produce it. The shell 3 is thus reduced in weight, to the advantage of the overall weight of the molding unit 1. The result of this is a reduction of the weights handled by the operators responsible for maintenance and therefore an improvement in the ergonomics of the machine as well as a reduction in the interruption in production times. The reduction in weight further contributes to a reduction of the inertia of such a molding unit, which can provide certain advantages when the unit is carried by a carousel.

Second, the taking of temperature performed by the temperature probe 28 in the area of the shell 3 (and more specifically near the inner wall 4) makes it possible to evaluate precisely the temperature prevailing in the mold 2, and therefore to achieve a precise heat regulation of it.

Third, the connectors 35, 36 make it possible to proceed to a quick and automatic connection of the temperature probe 28 to the variator 29 during the mounting of the shell 3 in the shell-carrier 10, which reduces the time needed for replacing a shell 3.

1. Molding unit (1) for producing a container from a blank of plastic material, this molding unit (1) comprising:
a mold (2) having the impression of the container to be formed, this mold (2) including a pair of shells (3) each having an inner wall (4) that defines a portion of the impression of a body of the container to be formed, these shells (3) being mounted mobile in relation to one another between an open position in which the shells (3) are separated from one another and a closed position where the shells (3) are applied against one another to form mutually the impression of the body of the container;
a pair of shell-carriers (10) on each of which a shell (3) is attached in a removable manner;
a device (24) for heat regulation of the mold (2), which comprises at least one radiator (25) able to exchange heat with it;
wherein:
the or each radiator (25) is integrated with a shell-carrier (10),
the heat-regulating device (24) comprises:
at least one temperature probe (28) integrated with a shell (3) to measure the temperature near the inner wall (4),
a variator (29) connected both to the temperature probe (28) as well as to the radiator (25), this variator (29) being arranged to modulate the temperature of the radiator (25) as a function of the temperature measured by the temperature probe (28).

2. Molding unit (1) according to claim 1, wherein the heat-regulating device (24) comprises a radiator (25) integrated with each shell-carrier (10).

3. Molding unit (1) according to claim 1, wherein the heat-regulating device (24) comprises:
a primary connector (35) connected to the temperature probe (28) and mounted in the shell (3) carrying the temperature probe (28), and
a secondary connector (36) connected to the variator (29) and mounted in the shell-carrier (10) to which the shell (3) carrying the temperature probe (28) is attached, this secondary connector (36) being complementary to the primary connector (35) so as to work with it when the shell (3) is attached on its shell-carrier (10).

4. Molding unit (1) according to claim 1, wherein the radiator (25) comprises at least one electrical resistor (26) housed in a complementary hole (27) made in the shell-carrier (10).

5. Molding unit (1) according to claim 4, wherein the radiator (25) comprises a series of electrical resistors (26) housed in a series of complementary holes (27) made in the shell-carrier (10).

6. Molding unit (1) according to claim 1, wherein the temperature probe (28) is mounted in a blind hole (30) made in the shell (3), the temperature probe (28) extending to an internal end (31) of the blind hole (30) located near the inner wall (4) of the shell (3).

7. Molding unit (1) according to claim 1, wherein the mold (2) includes a mold bottom (8) that has an upper surface (9) having the impression of the bottom of the container to be formed.

8. Molding unit (1) according to claim 2, wherein the heat-regulating device (24) comprises:
a primary connector (35) connected to the temperature probe (28) and mounted in the shell (3) carrying the temperature probe (28), and
a secondary connector (36) connected to the variator (29) and mounted in the shell-carrier (10) to which the shell (3) carrying the temperature probe (28) is attached, this secondary connector (36) being complementary to the primary connector (35) so as to work with it when the shell (3) is attached on its shell-carrier (10).

9. Molding unit (1) according to claim 2, wherein the radiator (25) comprises at least one electrical resistor (26) housed in a complementary hole (27) made in the shell-carrier (10).

10. Molding unit (1) according to claim 3, wherein the radiator (25) comprises at least one electrical resistor (26) housed in a complementary hole (27) made in the shell-carrier (10).

11. Molding unit (1) according to claim 2, wherein the temperature probe (28) is mounted in a blind hole (30) made in the shell (3), the temperature probe (28) extending to an internal end (31) of the blind hole (30) located near the inner wall (4) of the shell (3).

12. Molding unit (1) according to claim 3, wherein the temperature probe (28) is mounted in a blind hole (30) made in the shell (3), the temperature probe (28) extending to an internal end (31) of the blind hole (30) located near the inner wall (4) of the shell (3).

13. Molding unit (1) according to claim 4, wherein the temperature probe (28) is mounted in a blind hole (30) made in the shell (3), the temperature probe (28) extending to an internal end (31) of the blind hole (30) located near the inner wall (4) of the shell (3).

14. Molding unit (1) according to claim 5, wherein the temperature probe (28) is mounted in a blind hole (30) made in the shell (3), the temperature probe (28) extending to an internal end (31) of the blind hole (30) located near the inner wall (4) of the shell (3).

15. Molding unit (1) according to claim 2, wherein the mold (2) includes a mold bottom (8) that has an upper surface (9) having the impression of the bottom of the container to be formed.

16. Molding unit (1) according to claim 3, wherein the mold (2) includes a mold bottom (8) that has an upper surface (9) having the impression of the bottom of the container to be formed.

17. Molding unit (1) according to claim 4, wherein the mold (2) includes a mold bottom (8) that has an upper surface (9) having the impression of the bottom of the container to be formed.

18. Molding unit (1) according to claim 5, wherein the mold (2) includes a mold bottom (8) that has an upper surface (9) having the impression of the bottom of the container to be formed.

19. Molding unit (1) according to claim 6, wherein the mold (2) includes a mold bottom (8) that has an upper surface (9) having the impression of the bottom of the container to be formed.

20. Molding unit (1) according to claim 8, wherein the mold (2) includes a mold bottom (8) that has an upper surface (9) having the impression of the bottom of the container to be formed.
